(19) United States
(12) Patent Application Publication
(10) Pub. No.: US 2024/0085686 A1
(43) Pub. Date: Mar. 14, 2024

(54) METHOD, DEVICE AND SYSTEM FOR ENHANCING IMAGE QUALITY

(71) Applicant: Siemens Healthcare Diagnostics Inc., Tarrytown, NY (US)

(72) Inventors: Abhijeet A. Joshi, Bangalore (IN); Mohiudeen Azhar, Bangalore (IN)

(73) Assignee: Siemens Healthcare Diagnostics Inc., Tarrytown, NY (US)

(21) Appl. No.: 18/263,369

(22) PCT Filed: Mar. 8, 2021
(86) PCT No.: PCT/US2021/070249

§ 371 Date: Jul. 28, 2023

(51) Int. Cl. G02B 21/36; G06T 5/00

(52) U.S. Cl. CPC G02B 21/365; G06T 5/006; G06T 2207/10056; G06T 2207/20048

(57) ABSTRACT

A method, device and system for enhancing image quality of an image is provided. In one aspect, the method includes illuminating a sample with a light source associated with an imaging device. Further, the method includes simulating a transmission wave at a sensor plane of the imaging device for a light wave from illuminating the sample. Additionally, the method includes determining a phase and amplitude information associated with the light wave based on the transmission wave. The method also includes determining at least one microscope transfer function associated with the imaging device based on the phase and amplitude information. Furthermore, the method includes generating a modified mi-croscope transfer function using a Zernike function based on the at least one microscope transfer function in an iterative procedure and enhancing the image quality associated with the im-age using the modified microscope transfer function.

### FIELD OF TECHNOLOGY

The present invention relates to a method, device and system for processing images. In particular, the invention relates to a method, device and system for enhancing image quality of images.

### BACKGROUND

Fourier Ptychography Microscopy (FPM) is a microscopy technique for enhancing resolution of images without compromising on the field of view. This is achieved by illuminating the sample at multiple angles and subsequently stitching the image information acquired during each illumination in Fourier domain. In order that the image reconstruction be accurate, the knowledge of microscope transfer function is essential. The microscope transfer function takes into consideration optical aberrations associated with the lens assembly in the imaging device. Such microscope transfer function is known as pupil function in the Fourier domain. At present, obtaining a priori knowledge of the pupil function is difficult as the pupil function is dependent on aberrations, rotational, positional and focal alignment as well as location of region of interest with respect to the entire field of view to be captured in the image.

Currently, methods such as Embedded Pupil Recovery (EPRY) employ method to estimate pupil function simultaneously along with sample representation. However, low signal-to-noise ratio associated with images having high angle illumination and sensor noise results in noise in the recovered pupil function in EPRY method. This may affect the image reconstruction. Additionally, the stitching paradigm introduces speckle artifacts in the recovered pupil function subsequently affecting quality of the image reconstruction and the speed of convergence. Therefore, there is a need for a method, device and system which enables effective removal of artifacts and mitigates noise in pupil function recovery.

The object of the invention is therefore to provide a method, device and system that enables enhancement of image quality in images.

### SUMMARY

The invention achieves the object by a method of enhancing image quality of an image. In an embodiment, the method comprises illuminating a sample with a light source associated with an imaging device. The imaging device may be, for example, a Fourier Ptychography Microscope. The imaging device may include, for example, one or more controllable light sources placed at discrete positions, a tube lens, one or more objective lens and an image capturing module. The light sources may be configured to emit light of a predefined wavelength distribution and at a plurality of angles such that the sample is illuminated at multiple angles. The sample may include any object that may require a magnified visualization. In an embodiment, a plurality of images of the sample may be captured at different angles and information thus obtained may be utilized to synthesize a final representation of the sample, in an embodiment in Fourier domain. The method further comprises simulating a transmission wave at a sensor plane of the imaging device, particularly the image capturing module. The wave may be simulated using a forward microscopic imaging model corresponding to the light wave illuminating the sample, emitted by the light source. The forward microscopic imaging model may include, for example, Fourier transformation of the light wave. Fourier transform is applied to functions associated with the light wave to decompose them into functions associated with spatial frequency. Inverse formulation paradigm enables identification of microscope transfer function associated with the imaging device and sample spectrum. Sample spectrum includes phase and amplitude information at the sample focal plane. The microscope transfer function may be, for example, pupil function of the imaging device. In an embodiment, the microscope transfer function associated with the imaging device may be determined using the embedded pupil function recovery (EPRY) algorithm.

The method further includes determining a phase and amplitude information associated with the light wave based on the transmission wave. In an embodiment, an inverse formulation of the transmission wave may also be simulated. Inverse formulation of the wave enables converting functions associated with spatial frequency to functions associated with the light wave, i.e. the functions of the light wave are reversed from Fourier domain to spatial domain. From the inverse formulation, at least one microscope transfer function associated with the imaging device is determined.

Further, the method comprises generating a modified microscope transfer function based on the at least one microscope transfer function determined from the inverse formulation. The microscope transfer function may be modified using Zernike functions. Zernike functions are a sequence of polynomials that are continuous and orthogonal over a unit circle. The orthogonal polynomials arise in an expansion of a wavefront function for optical systems with circular pupils.

The method further comprises enhancing the image quality associated with the image using the modified microscope transfer function. In an embodiment, the image quality of the image may be enhanced by feeding the modified microscope transfer function to the process of simulating a new transmission wave at the sensor plane of the imaging device. In a further embodiment, the modified microscope transfer function may be fed to a forward simulating step of a recovery process, wherein a new transmission wave or a propagation wave is simulated at the sensor plane of the imaging device. Recovery process may be iteratively continued until a sufficiently resolved and noise-free image is obtained. Advantageously, noise in the recovered pupil function is reduced. Therefore, the quality of the image is enhanced.

According to an embodiment, generating the modified microscope transfer function comprises decomposing amplitude and phase information associated with the microscope transfer function into Zernike functions. The Zernike functions may include Zernike radial modes and associated Zernike angular modes. These Zernike modes may represent a plurality of aberrations such as defocus, astigmatism, coma, etc. In an embodiment, the basis set for Zernike functions may be limited/truncated to 36 or less so as to preserve important modes in the pupil function while eliminating the noise from the pupil function. A thresholding based on relative importance may be applied on the truncated Zernike modes. The method further comprises recovering the amplitude and phase of the pupil by inverse Zernike transform using thresholded and truncated Zernike coefficients, and thus recover modified microscope transfer function. Advantageously, the Zernike functions enable effective removal of noise factor accrued in the microscope transfer function during the inverse formulation procedure.

According to another embodiment, simulating the transmission wave comprises initializing a first guess associated with the microscope transfer function of the imaging device and the sample spectrum. For example, the first guess for the sample spectrum may be generated using an upscaled low angle brightfield low resolution image. The first guess associated with the microscope transfer function and the sample spectrum may be used to simulate a transmission wave at the sensor plane of the imaging device. In a further embodiment, the transmission wave may be a low-resolution wave. Advantageously, determination of the actual microscope transfer function associated with the imaging device and the sample spectrum is enabled by iteratively minimizing the loss between the measured and simulated intensities/amplitudes.

According to an embodiment, determining the at least one microscope transfer function associated with the imaging device comprises identifying an intensity associated with an image of the sample. The intensity may be measured, for example, based on a pixel analysis of the image obtained from the imaging device. For example, a histogram analysis may be performed to obtain intensity measurement. The method further comprises computing an intensity constraint based on the measured intensity of the image. The intensity constraint may be the intensity correction to be applied to the simulated wave in spatial domain by first applying inverse Fourier transform. Particularly, the intensity constraint is applied wherein modulus of the simulated transmission wave is replaced by a square root of real intensity measurement captured with an illumination wavevector. Further, the method comprises generating an updated wave by applying the intensity constraint to the simulated transmission wave. The method further comprises applying Fourier transform to the updated wave and determining the at least one microscope transfer function using the Fourier transform of the updated wave. Advantageously, the determined microscope transfer function is further used for generating updated microscope transfer function using Zernike functions. Therefore, the quality of the image is enhanced.

The object of the invention is also achieved by an imaging device for enhancing the image quality of an image. The device comprises an imaging module configured to capture a plurality of images, one or more processing units, and a memory coupled to the one or more processing units. The memory comprises a image processing module configured to perform the method steps as described above.

The invention relates in another aspect to a system for enhancing image quality of an image. According to an embodiment, the system includes one or more one or more servers and an imaging device coupled to the one or more servers. The one or more servers comprise instructions, which when executed causes the one or more servers to perform the method steps as described above.

The invention relates in one aspect to a computer program product comprising a computer program, the computer program being loadable into a storage unit of a system, including program code sections to make the system execute the method according to an aspect of the invention when the computer program is executed in the system.

The invention relates in one aspect to a computer-readable medium, on which program code sections of a computer program are saved, the program code sections being loadable into and/or executable in a system to make the system execute the method according to an aspect of the invention when the program code sections are executed in the system.

The realization of the invention by a computer program product and/or a computer-readable medium has the advantage that already existing management systems can be easily adopted by software updates in order to work as proposed by the invention.

The computer program product can be, for example, a computer program or comprise another element apart from the computer program. This other element can be hardware, for example a memory device, on which the computer program is stored, a hardware key for using the computer program and the like, and/or software, for example a documentation or a software key for using the computer program.

### BRIEF DESCRIPTION OF THE DRAWINGS

The present invention is further described hereinafter with reference to illustrated embodiments shown in the accompanying drawings, in which:

FIG. 1 illustrates a block diagram of a client-server architecture which provides a geometric modeling of components representing different parts of a real-world object, according to an embodiment of the present invention.

FIG. 2 illustrates a block diagram of a data processing system in which an embodiment for enhancing image quality of an image can be implemented.

FIG. 3 illustrates a flowchart of a method of enhancing image quality of an image, according to an embodiment of the invention.

FIG. 4 illustrates a flowchart of a method of generating a modified microscope transfer function, according to an embodiment of the invention.

FIG. 5 illustrates a flowchart of a method of determining at least one microscope transfer function, according to an embodiment of the invention.

FIG. 6 illustrates an exemplary embodiment of an improved image generated after implementation of the method of enhancing image quality.

FIG. 7 illustrates another exemplary embodiment of improved microscope transfer function generated after implementation of the method of enhancing image quality.

### DETAILED DESCRIPTION

Hereinafter, embodiments for carrying out the present invention are described in detail. The various embodiments are described with reference to the drawings, wherein like reference numerals are used to refer to like elements throughout. In the following description, for purpose of explanation, numerous specific details are set forth in order to provide a thorough understanding of one or more embodiments. It may be evident that such embodiments may be practiced without these specific details.

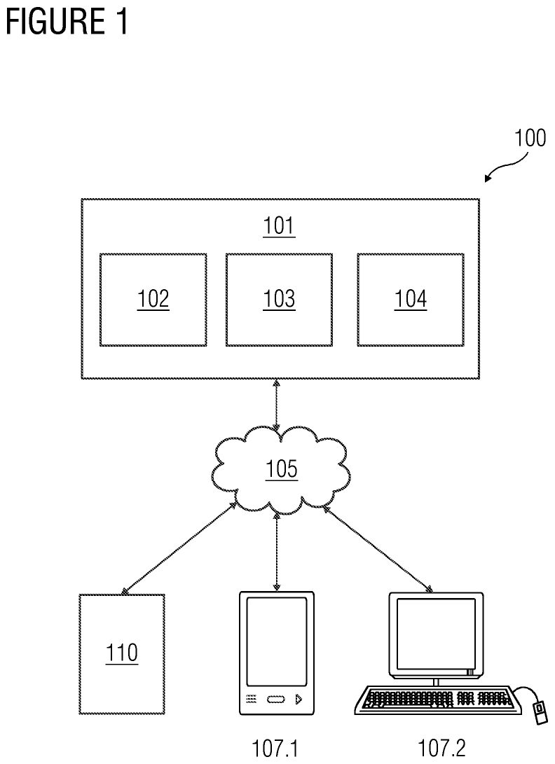

FIG. 1 provides an illustration of a block diagram of a client-server architecture that is a geometric modelling of components representing different parts of real-world objects, according to an embodiment. The client-server architecture 100 includes a server 101 and a plurality of client devices 107A-N. Each of the client device 107A-N is connected to the server 101 via a network 105, for example, local area network (LAN), wide area network (WAN), WiFi, etc. In one embodiment, the server 101 is deployed in a cloud computing environment. As used herein, “cloud computing environment” refers to a processing environment comprising configurable computing physical and logical resources, for example, networks, servers, storage, applications, services, etc., and data distributed over the network 105, for example, the internet. The cloud computing environment provides on-demand network access to a shared pool of the configurable computing physical and logical resources. The server 101 may include a database 102 that comprises images captured by imaging devices. The server 101 may include an image processing module 103 that is configured to enhance image quality of images. Additionally, the server 101 may include a network interface 104 for communicating with the client device 107A-N via the network 105.

The client device 107A-N are user devices, used by users, for example, a medical personnel such as a pathologist, physician, etc. In an embodiment, the user device 107A-N may be used by the user to receive enhanced images. The data can be accessed by the user via a graphical user interface of an end user web application on the user device 107A-N. In another embodiment, a request may be sent to the server 101 to access the images via the network 105. An imaging device 110 may be connected to the server 101 through the network 105. The device 110 may be configured to capture a plurality of images of a sample. The imaging device 110 may be, for example, a Fourier Ptychography microscope.

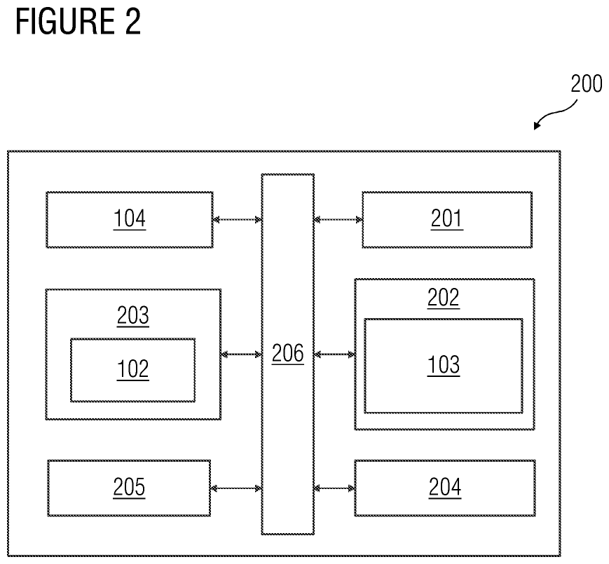

FIG. 2 is a block diagram of a data processing system 101 in which an embodiment can be implemented, for example, as a system 101 for enhancing image quality of an image, configured to perform the processes as described therein. It is appreciated that the server 101 is an exemplary implementation of the system in FIG. 2. In FIG. 2, said data processing system 101 comprises a processing unit 201, a memory 202, a storage unit 203, an input unit 204, an output unit 205, a bus 206, and a network interface 104.

The processing unit 201, as used herein, means any type of computational circuit, such as, but not limited to, a microprocessor, microcontroller, complex instruction set computing microprocessor, reduced instruction set computing microprocessor, very long instruction word microprocessor, explicitly parallel instruction computing microprocessor, graphics processor, digital signal processor, or any other type of processing circuit. The processing unit 201 may also include embedded controllers, such as generic or programmable logic devices or arrays, application specific integrated circuits, single-chip computers, and the like.

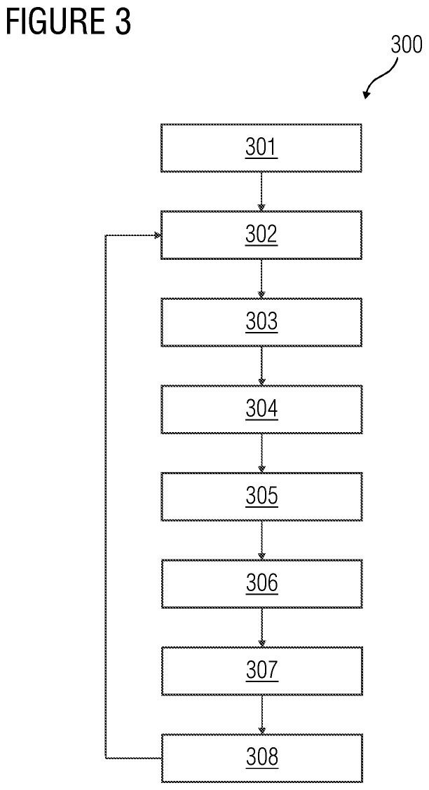

The memory 202 may be volatile memory and non-volatile memory. The memory 202 may be coupled for communication with said processing unit 201. The processing unit 201 may execute instructions and/or code stored in the memory 202. A variety of computer-readable storage media may be stored in and accessed from said memory 202. The memory 202 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 202 includes an image processing module 103 stored in the form of machine-readable instructions on any of said above-mentioned storage media and may be in communication to and executed by processor 201. When executed by the processor 201, the image processing module 103 causes the processor 201 to process images to enhance the image quality. Method steps executed by the processor 201 to achieve the abovementioned functionality are elaborated upon in detail in FIGS. 3, 4 and 5.

The storage unit 203 may be a non-transitory storage medium which stores a database 102. The database 102 is a repository of images captured by the imaging device 300. The input unit 204 may include input means such as keypad, touch-sensitive display, camera (such as a camera receiving gesture-based inputs), etc. capable of receiving input signal such as a medical image. The bus 206 acts as interconnect between the processor 201, the memory 202, the storage unit 203, the input unit 204, the output unit 205 and the network interface 104.

Those of ordinary skilled in the art will appreciate that said hardware depicted in FIG. 1 may vary for particular implementations. For example, other peripheral devices such as an optical disk drive and the like, Local Area Network (LAN)/Wide Area Network (WAN)/Wireless (e.g., Wi-Fi) adapter, graphics adapter, disk controller, input/output (I/O) adapter also may be used in addition or in place of the hardware depicted. Said depicted example is provided for the purpose of explanation only and is not meant to imply architectural limitations with respect to the present disclosure.

A data processing system 101 in accordance with an embodiment of the present disclosure includes an operating system employing a graphical user interface. Said operating system permits multiple display windows to be presented in the graphical user interface simultaneously with each display window providing an interface to a different application or to a different instance of the same application. A cursor in said graphical user interface may be manipulated by a user through a pointing device. The position of the cursor may be changed and/or an event such as clicking a mouse button, generated to actuate a desired response.

One of various commercial operating systems, such as a version of Microsoft Windows™, a product of Microsoft Corporation located in Redmond, Washington may be employed if suitably modified. Said operating system is modified or created in accordance with the present disclosure as described.

Disclosed embodiments provide systems and methods for processing medical images. In particular, the systems and methods may enhance image quality of images.

FIG. 3 illustrates a flowchart of a method 300 of enhancing image quality of an image. At step 301, a sample whose image is to be captured is illuminated with a light source. The light source may be associated with the imaging device 110. In an embodiment, the imaging device 110 is a Fourier Ptychography microscope. The imaging device 110 may include an imaging module comprising one or more light sources, a tube lens, one or more objective lens and an image capturing module. The light source may have specific wavelength distribution. In an embodiment, the light emitted from the light source passes through a microscopic slide which includes the sample to be imaged. The objective lens assembly in the imaging module may be used to visualize and magnify the one or more components on the microscopic slide. The tube lens is used in microscopes to enable creation of real images from intermediate images placed at infinity. Therefore, tube lens enable visualization of infinity corrected images. The image capturing module may include imaging lenses and an imaging sensor, configured to capture an image of the illuminated microscopic slide. The imaging sensor may be, for example a charge-coupled device (CCD) or a complementary metal oxide semiconductor (CMOS). In an embodiment, the light source includes 256 light emitting diodes (LEDs). Each LED may be configured to emit light at a pre-defined angle on to the sample. An image may be obtained/captured for each of the pre-defined angle and may be stitched to obtain a final image of the sample.

At step 302, a first guess associated with a microscope transfer function and sample spectrum of the imaging device 110 is determined. The microscope transfer function may be, for example, pupil function. The first guess for the pupil function and the sample spectrum may be determined, for example, using a brightfield low-resolution image of the sample for the sample spectrum and a binary circular mask for the pupil function. At step 303, a transmission wave is simulated in Fourier domain at an imaging sensor plane of the imaging device 110 for a light wave originating from the light source of the imaging device 110. Transmission wave comprises phase and amplitude information. In an embodiment, the phase and amplitude information may be fed to an embedded pupil function recovery (EPRY) algorithm. At step 304, an inverse Fourier transformed wave is generated from the transmission wave. Therefore, the wave is reconstructed.

At step 305, an intensity constraint associated with the light wave is computed. In an embodiment, the intensity constraint may be an intensity correction to be applied to the simulated wave. For example, the intensity constraint may be applied wherein modulus of the simulated transmission wave is replaced by a square root of real intensity measurement captured for a corresponding illumination angle. The measure intensity value associated with the light wave may be determined based on pixel analysis of the image. For example, a histogram analysis may be performed on the image to obtain a measured intensity value of the light wave. Further, the calculated intensity value of the light wave may be determined from the EPRY algorithm.

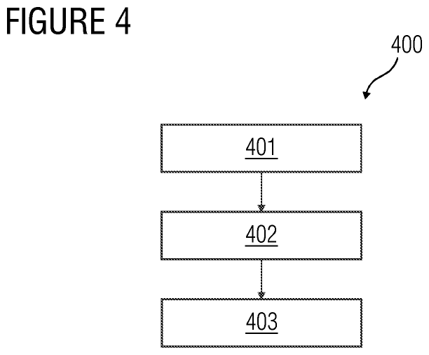

At step 306, a Fourier transformation is performed on the light wave to obtain an updated phase and amplitude information associated with the light wave, based on the computed intensity constraint. These updated phase and amplitude information are used at step 307 to determine at least one pupil function and sample spectrum associated with the imaging device 110. The EPRY algorithm may be used to derive the pupil function and the sample spectrum associated with the imaging device 110. In an embodiment, the derived pupil function may include noise and artifacts thereby generating noise and artifacts in the final image. In order to mitigate the effect of noise, the pupil function is decomposed into Zernike functions, subsequently truncating and thresholding and inverse Zernike transforming at step 308, thereby generating a modified pupil function. Zernike functions are a sequence of polynomials that are orthogonal. Zernike functions may be used to correct wavefront aberrations in lenses of the imaging device 110. The method steps associated with generating the modified pupil function are elaborated in further detail in FIG. 4. In a further embodiment, the modified pupil function and sample spectrum from step 308 may be used as a next guess of pupil function and sample spectrum associated with the imaging device, using which a subsequent transmission wave may be simulated. The loop may be continued until a sufficiently resolved, noise-free image associated with the sample is obtained.

FIG. 4 illustrates a flowchart of a method 400 of generating the modified microscope transfer function, according to an embodiment of the present invention. At step 401, a phase and amplitude information associated with the determined pupil function is determined using the EPRY algorithm. At step 402, the amplitude and phase information associated with the pupil function is decomposed into the Zernike functions. The Zernike functions include Zernike radial modes and Zernike angular modes which depict various aberrations such as defocus, astigmatism, coma, etc. A basis set of the Zernike functions may be limited/truncated to 36 or less so as to preserve important modes in recovered pupil function while eliminating noise from the image. Further importance based thresholding may be applied to the truncated Zernike basis set. At step 403, the amplitude and phase information associated with the pupil function are recovered using inverse Zernike transform on the truncated and thresholded coefficients to generate the modified microscope transfer function.

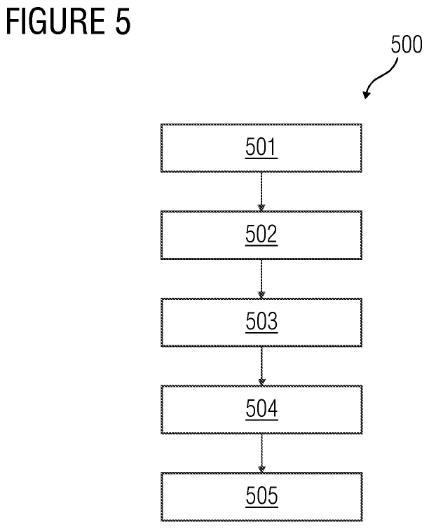

FIG. 5 illustrates a flowchart of a method 500 of determining at least one microscope transfer function associated with the imaging device 110, according to an embodiment of the present invention. At step 501, an intensity associated with the light wave from the light source is identified. For example, the intensity may be identified based on a pixel analysis of the image of the sample. In an embodiment, the intensity associated with the light wave may be determined only once during an implementation instance of the invention. A histogram analysis may be performed of the image to identify the intensity of the light wave illuminating the sample. At step 502, an intensity constraint is computed based on the identified intensity of light. The intensity constraint may be applied wherein modulus of the simulated transmission wave is replaced by a square root of real intensity measurement captured with an illumination wavevector. At step 503, an updated wave is generated based on the intensity constraint and at step 504, a Fourier transform of the updated wave is simulated. Further, at step 505, the at least one microscope transfer function/pupil function is determined based on the updated amplitude and phase information.

### Exemplary Embodiment

Fourier Ptychographic microscopy involves illuminating a given sample at multiple angles and capturing a series of images corresponding to such illuminations. The image acquisition process may be modelled as the following:

For n^{th} LED, the sample S(r) with sample spectrum S(u) in Fourier domain, is illuminated by a light at an angle (wavevector Uₙ). Exiting wave gets convoluted by a point spread function, p(r) of the imaging device 110, i.e. exiting spectrum gets multiplied by the pupil function P(u) in Fourier domain to form an image at the image sensor plane. This is depicted as:

(I_{U}_{ₙ}=|F⁻¹{F[e(r)]*F[p(r)]}|²=|F⁻¹{S(u−Uₙ)*P(u)}|²)

Where S(u)=F{s(r)} is the Fourier spectrum of the sample and P(u)=F{p(r)} is the pupil function of the imaging device 110.

If phase retrieval algorithm only renews sample spectrum without updating the pupil function, the quality of the image generated may be poor due to an insufficiently estimated pupil function. Therefore, the EPRY algorithm is used to recover the functions S(u) and P(u) for all measured angles of the LEDs.

A first guess of the pupil function P₀(u) and sample spectrum S₀(u) is provided to the EPRY algorithm to estimate both pupil function and sample spectrum. At n^{th} inner loop corresponding to n\hat{ }th LED, with pupil function Pₙ(u) and sample spectrum Sₙ(u), a low-resolution wave is simulated in Fourier domain for the incident wavevector Uₙ at the image sensor plane by a multiplication:

$$\\ {∅}_{n} ( u ) = {P}_{n} ( u ) {S}_{n} ( u - {U}_{n} )$$

An inverse Fourier transform wave is simulated using:

$$\\ {Φ}_{n} ( r ) = \{ {F}^{- 1} {∅}_{n} ( u ) \}$$

The intensity constraint is applied wherein modulus of the simulated inverse Fourier transformed wave is replaced by a square root of real intensity measurement I_{U}_{ₙ}(r), captured with the illumination wavevector Uₙ:

$$\\ {Φ}_{n}^{’} ( r ) = \sqrt{{I}_{Un} ( r )} \frac{{Φ}_{n} ( r )}{\vert {Φ}_{n} ( r ) \vert}$$

An updated exit wave is simulated via a Fourier transform:

$$\\ {∅}_{n}^{’} ( u ) = \{ F {Φ}_{n}^{′} ( r ) \}$$

and an updated pupil function and sample spectrum is determined. The sample spectrum update function is given by:

$$\\ {S}_{n + 1} ( u ) = {S}_{n} ( u ) + α \frac{{P}_{n} * ( u + {U}_{n} )}{{\vert {P}_{n} ( u + {U}_{n} ) \vert}_{max}^{2}} [ {∅}_{n}^{′} ( u + {U}_{n} ) - {∅}_{n} ( u + {U}_{n} ) ]$$

The pupil update function is given by:

$$\\ {P}_{n + 1} ( u ) = {P}_{n} ( u ) + β \frac{{S}_{n} * ( u + {U}_{n} )}{{\vert {S}_{n} ( u + {U}_{n} ) \vert}_{max}^{2}} [ {∅}_{n}^{′} ( u ) - {∅}_{n} ( u ) ]$$

The updated pupil function is projected into Zernike functions as depicted below:

$$\\ {Z}_{n}^{m} ( r , θ ) = {R}_{n}^{m} ( r ) cos m θ for m \geq 0$$

$$\\ {Z}_{n}^{m} ( r , θ ) = {R}_{n}^{m} ( r ) sin m θ for m < 0$$

Where m and n are non-negative integers with n≥m≥0, θ is azimuthal angle and r is radial distance 0≤r≤1, and Rₙ^{m} are radial polynomials.

The phase and amplitude information are decomposed into the Zernike functions and reconstructed to obtain a modified pupil function. This modified pupil function is fed into the EPRY algorithm for simulation of new transmission waves, for a plurality of iterations, thereby generating an image of the sample which has reduced noise.

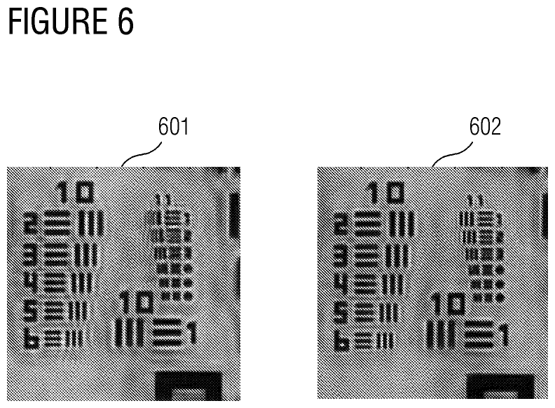

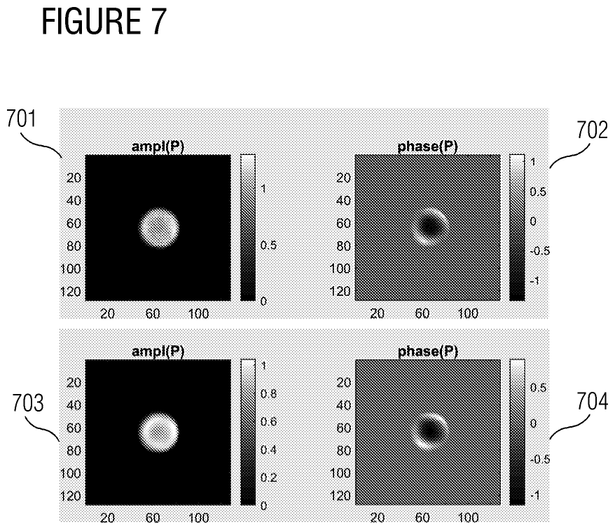

FIGS. 6 and 7 illustrate exemplary embodiments of improved images generated after implementation of the method of enhancing image quality. In FIG. 6, illustration 601 depicts an image reconstructed at 50^{th} iteration without pupil projection on to Zernike functions. Illustration 602 depicts an image at 50^{th} iteration with pupil projection on to Zernike functions. Image 602 has lesser noise and artifacts in comparison to image 601. In FIG. 7, images 701 and 702 are amplitude and phase images of pupil function recovered without projections onto Zernike functions using EPRY algorithm. The images 701 and 702 include noise, thereby introducing artifacts in the imaged object. Images 703 and 704 are the amplitude and phase images of recovered pupil function with projection of pupil functions on to Zernike functions/modes, at each loop of EPRY algorithm. The images 703 and 704 include lesser noise and artifacts, enabling sample reconstruction with reduced noise and artifacts.

Advantageously, the invention enables removal of outliers and reconstruction noise in images generated using Fourier Ptychography microscope. The method improves convergence rate of the algorithm thereby reducing computational requirement. Further, an improved reconstructed image of the sample is obtained faster than traditional methods. The method enables correction of noisy pupil function which may introduce artifacts in the image.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

What is claimed is:

1. A method of enhancing image quality of an image, the method comprising computer implemented steps of:
illuminating a sample with one or more light sources associated with an imaging device, wherein the one or more light sources are placed at discrete positions;
measuring at a sensor plane of the imaging device an intensity associated with a light wave from the one or more light sources;
simulating a transmission wave at the sensor plane of the imaging device for the light wave;
determining a phase and amplitude information associated with the light wave at a sample plane associated with the imaging device based on simulated transmission wave and the measured intensity of the light wave;
determining at least one microscope transfer function associated with the imaging device based on the phase and amplitude information;
generating a modified microscope transfer function using a Zernike function based on the at least one microscope transfer function; and
enhancing the image quality associated with the image using the modified microscope transfer function.

2. The method according to claim 1, wherein the microscope transfer function is a pupil function associated with the imaging device.

3. The method according to claim 1, wherein generating the modified microscope transfer function comprises:
decomposing amplitude and phase information associated with the microscope transfer function into the Zernike functions;
truncating the Zernike functions to 36 or less functions;
thresholding Zernike functions; and
recovering the amplitude and phase information to generate the modified microscope transfer function.

4. The method according to claim 1, wherein enhancing the image quality associated with the image using the modified microscope transfer function comprises applying the modified microscope transfer function to simulate a propagation wave at the sensor plane of the imaging device.

5. The method according to claim 1, wherein simulating the transmission wave comprises:
initializing a first guess associated with the microscope transfer function of the imaging device and a sample spectrum; and
simulating the transmission wave based on the first guess associated with the microscope transfer function and sample spectrum of the imaging device.

6. The method according to claim 1, wherein determining the at least one microscope transfer function associated with the imaging device comprises:
measuring the intensity associated with the light wave originating from the light source of the imaging device at the sensor plane of the imaging device;
computing an intensity constraint based on the measured intensity of the light at the sensor plane of the imaging device;
generating an updated wave using the intensity constraint;
applying Fourier transform to the updated wave; and
updating at least one microscope transfer function and sample spectrum.

7. An imaging device comprising:
an imaging module configured to capture a plurality of images;
one or more processing units; and
a memory coupled to the one or more processing units, the memory comprising an image processing module configured for:
illuminating a sample with one or more light sources associated with an imaging device, wherein the one or more light sources are placed at discrete positions;
measuring at a sensor plane of the imaging device an intensity associated with a light wave from the one or more light sources;
simulating a transmission wave at the sensor plane of the imaging device for the light wave;
determining a phase and amplitude information associated with the light wave at a sample plane associated with the imaging device based on simulated transmission wave and the measured intensity of the light wave;
determining at least one microscope transfer function associated with the imaging device based on the phase and amplitude information;
generating a modified microscope transfer function using a Zernike function based on the at least one microscope transfer function; and
enhancing the image quality associated with the image using the modified microscope transfer function.

8. The imaging device according to claim 7, wherein in generating the modified microscope transfer function, the image processing module is configured for:
decomposing amplitude and phase information associated with the microscope transfer function into the Zernike functions;
truncating the Zernike functions to 36 or less functions;
thresholding Zernike functions; and
recovering the amplitude and phase information to generate the modified microscope transfer function.

9. The imaging device according to claim 7, wherein in simulating the transmission wave, the image processing module is configured for:
initializing a first guess associated with the microscope transfer function of the imaging device and a sample spectrum; and
simulating the transmission wave based on the first guess associated with the microscope transfer function and sample spectrum of the imaging device.

10. The imaging device according to claim 7, wherein in determining the at least one microscope transfer function associated with the imaging device, the image processing module is configured for:
measuring the intensity associated with the light wave originating from the light source of the imaging device at the sensor plane of the imaging device;
computing an intensity constraint based on the measured intensity of the light at the sensor plane of the imaging device;
generating an updated wave using the intensity constraint;
applying Fourier transform to the updated wave; and
updating at least one microscope transfer function and sample spectrum.

11. The imaging device according to claim 7, wherein the imaging module comprises:
one or more controllable light sources placed at a discrete position;
a tube lens;
one or more objective lens; and
an imaging capturing module.

12. A system comprising:
one or more servers;
an imaging device coupled to the one or more servers;
the one or more servers comprising instructions, which when executed causes the one or more servers to:
illuminate a sample with one or more light sources associated with an imaging device, wherein the one or more light sources are placed at discrete positions;
measure at a sensor plane of the imaging device an intensity associated with a light wave from the one or more light sources;
simulate a transmission wave at the sensor plane of the imaging device for the light wave;
determine a phase and amplitude information associated with the light wave at a sample plane associated with the imaging device based on simulated transmission wave and the measured intensity of the light wave;
determine at least one microscope transfer function associated with the imaging device based on the phase and amplitude information;
generate a modified microscope transfer function using a Zernike function based on the at least one microscope transfer function; and
enhance the image quality associated with the image using the modified microscope transfer function.

13. A non-transitory computer readable medium having machine-readable instructions stored therein, that when executed by a system, cause the system to:
illuminate a sample with one or more light sources associated with an imaging device, wherein the one or more light sources are placed at discrete positions;
measure at a sensor plane of the imaging device an intensity associated with a light wave from the one or more light sources;
simulate a transmission wave at the sensor plane of the imaging device for the light wave;
determine a phase and amplitude information associated with the light wave at a sample plane associated with the imaging device based on simulated transmission wave and the measured intensity of the light wave;
determine at least one microscope transfer function associated with the imaging device based on the phase and amplitude information;
generate a modified microscope transfer function using a Zernike function based on the at least one microscope transfer function; and
enhance the image quality associated with the image using the modified microscope transfer function.
